(19) United States
(12) Patent Application Publication
(10) Pub. No.: US 2021/0225318 A1
(43) Pub. Date: Jul. 22, 2021

(54) METHOD FOR ELIMINATING RESIDUAL IMAGE IN LIQUID CRYSTAL DISPLAY PANEL

(71) Applicant: WUHAN CHINA STAR OPTOELECTRONICS TECHNOLOGY CO., LTD., Wuhan, Hubei (CN)

(72) Inventor: Chunpeng GUO, Wuhan, Hubei (CN)

(21) Appl. No.: 16/302,260

(22) PCT Filed: Aug. 22, 2018
(86) PCT No.: PCT/CN2018/101664

§ 371 Date: Nov. 16, 2018

(30) Foreign Application Priority Data
Jul. 24, 2018 (CN) 201810818239.8

(51) Int. Cl. G09G 3/36; G09G 3/00

(52) U.S. Cl. CPC G09G 3/3696; G09G 3/006; G09G 2320/0247; G09G 2320/0276; G09G 2320/0257

(57) ABSTRACT

A method for eliminating residual image in a liquid crystal display panel is provided. The method includes steps as follows. A reference common voltage output by a common voltage generation circuit is shifted to eliminate a residual image. The reference common voltage is maintained, a first reference voltage bound of a gamma correction unit of the liquid crystal display panel is adjusted, so that a residual image is eliminated. The adjustment of remaining grayscales is completed in sequence.

### FIELD OF DISCLOSURE

The present disclosure relates to the field of liquid crystal display panels, and more particularly to a method for eliminating residual image in a liquid crystal display panel.

### BACKGROUND

Liquid crystal display panels are widely used in electronic equipment, such as display devices, TVs, mobile phones, electronic photo frames, etc. due to their unique advantages such as light weight, small size, low power consumption and low radiation.

A liquid crystal display panel applies a driving voltage difference to a liquid crystal layer located between a pixel electrode and a common electrode, thereby rotating liquid crystal molecules of the liquid crystal layer and controlling luminous flux to display an image. The driving voltage difference is relative to a potential of the common electrode (a common voltage). Therefore, driving the liquid crystal display requires a stable common voltage, but due to a capacitive coupling inside the liquid crystal display panel, a common voltage offset is often generated. When the common voltage rises or falls, residual images, grayscale anomaly, and crosstalk appear, affecting the display. The reason for the generation of the capacitive coupling inside the liquid crystal display panel is mainly due to a difference in liquid crystal capacitance caused by a deflection angle of the liquid crystal.

In order to solve the above problems, the prior art generally uses adjustment of an input voltage. The conventional method of adjusting the voltage is to adjust from high grayscale to low grayscale sequentially. The adjustment method is performed as follows. A reference common voltage is fixed, and a standard gamma curve remains unchanged, and then a reference voltage bound of a gamma correction unit is shifted. A range of movement and whether to move to left or to right should be tested step by step, until a checkerboard is lit, and there is no more residual image or slight residual image under this grayscale. After adjusting a grayscale, the reference voltage of this grayscale is fixed, and then another grayscale is adjusted. Although this method can improve the residual image to a certain extent, it is time-consuming and material-consuming, and it usually takes several days to adjust and consumes dozens of optical modules.

### TECHNICAL PROBLEM

In the prior art method for eliminating residual image in a liquid crystal display panel, since the reference voltage corresponding to each grayscale is adjusted from high grayscale to low grayscale sequentially, thereby increasing the time required for eliminating the residual image, and consuming optical modules required for eliminating the residual image.

### SUMMARY OF THE DISCLOSURE

The present disclosure provides a method for eliminating residual image in a liquid crystal display panel, including:

S10, shifting a reference common voltage output from a common voltage generation circuit for forming a first common voltage, where a selected value of a specific grayscale of the first common voltage ranges from greater than or equal to 48 grayscale to less than or equal to 127 grayscale to eliminate a first residual image of a particular grayscale image of the liquid crystal display panel;

S20, maintaining the reference common voltage, and detecting a second residual image of the particular grayscale image;

S30, adjusting a first reference voltage bound of a gamma correction unit of the liquid crystal display panel to obtain a second reference voltage, thereby eliminating the second residual image; and

S40, sequentially adjusting reference voltages corresponding to remaining grayscale images, so that others residual images of the liquid crystal display panel are eliminated.

According to one preferred embodiment of the present disclosure, positive and negative voltages of the first reference voltage are symmetric by utilizing the first common voltage as a symmetry axis.

According to one preferred embodiment of the present disclosure, positive and negative voltages of the second reference voltage are symmetric by utilizing the reference common voltage as a symmetry axis.

According to one preferred embodiment of the present disclosure, a translation amplitude of the second reference voltage and the first reference voltage is the same as a translation amplitude of the first common voltage and the reference common voltage.

According to one preferred embodiment of the present disclosure, a translation direction of the second reference voltage and the first reference voltage is opposite to a translation direction of the first common voltage and the reference common voltage.

According to one preferred embodiment of the present disclosure, the S10 further includes:

S101, adjusting the liquid crystal display panel to minimize flicker displayed by the liquid crystal display panel;

S102, switching an image of the liquid crystal display panel between a residual detection image and the particular grayscale image to detect the first residual image of the particular grayscale image.

According to one preferred embodiment of the present disclosure, the S101 further includes:

S1011, minimizing the flicker displayed by the liquid crystal display panel by adjusting a symmetry of the first reference voltage with respect to the reference common voltage and display brightness of the liquid crystal display panel.

According to one preferred embodiment of the present disclosure, a residual detection image is a black and white checkerboard pattern or a black and white stripe pattern.

According to one preferred embodiment of the present disclosure, the S40 further includes:

S401, switching an image of the liquid crystal display panel between a residual detection image and a grayscale image of a preset time interval;

S402, sequentially adjusting the reference voltages corresponding to grayscale images from a high grayscale image to a low grayscale image, where the reference voltage of one grayscale image is fixed after adjusting, and then a next grayscale image is adjusted, and the others residual images of the liquid crystal display panel are finally eliminated.

The present disclosure provides a method for eliminating residual image in a liquid crystal display panel, including:

S10, shifting a reference common voltage output from a common voltage generation circuit for forming a first common voltage to eliminate a first residual image of a particular grayscale image of the liquid crystal display panel;

S20, maintaining the reference common voltage, and detecting a second residual image of the particular grayscale image;

S30, adjusting a first reference voltage bound of a gamma correction unit of the liquid crystal display panel to obtain a second reference voltage, thereby eliminating the second residual image; and

S40, sequentially adjusting reference voltages corresponding to remaining grayscale images, so that others residual images of the liquid crystal display panel are eliminated.

According to one preferred embodiment of the present disclosure, positive and negative voltages of the first reference voltage are symmetric by utilizing the first common voltage as a symmetry axis.

According to one preferred embodiment of the present disclosure, positive and negative voltages of the second reference voltage are symmetric by utilizing the reference common voltage as a symmetry axis.

According to one preferred embodiment of the present disclosure, a translation amplitude of the second reference voltage and the first reference voltage is the same as a translation amplitude of the first common voltage and the reference common voltage.

According to one preferred embodiment of the present disclosure, a translation direction of the second reference voltage and the first reference voltage is opposite to a translation direction of the first common voltage and the reference common voltage.

According to one preferred embodiment of the present disclosure, the S10 further includes:

S101, adjusting the liquid crystal display panel to minimize flicker displayed by the liquid crystal display panel;

S102, switching an image of the liquid crystal display panel between a residual detection image and the particular grayscale image to detect first the residual image of the particular grayscale image.

According to one preferred embodiment of the present disclosure, the S101 further includes:

S1011, minimizing the flicker displayed by the liquid crystal display panel by adjusting a symmetry of the first reference voltage with respect to the reference common voltage and display brightness of the liquid crystal display panel.

According to one preferred embodiment of the present disclosure, a residual detection image is a black and white checkerboard pattern or a black and white stripe pattern.

According to one preferred embodiment of the present disclosure, the S40 further includes:

S401, switching an image of the liquid crystal display panel between a residual detection image and a grayscale image of a preset time interval;

S402, sequentially adjusting the reference voltages corresponding to grayscale images from a high grayscale image to a low grayscale image, where the reference voltage of one grayscale image is fixed after adjusting, and then a next grayscale image is adjusted, and the others residual images of the liquid crystal display panel are finally eliminated.

The present disclosure has the following advantages. In the method for eliminating residual image in a liquid crystal display panel of the present disclosure, the reference common voltage is maintained, and the grayscale adjustment is performed by changing the reference voltage, so the implementation process is simple. The time required for eliminating the residual images is reduced, and optical modules required for eliminating the residual images are decreased.

### BRIEF DESCRIPTION OF THE DRAWINGS

In order to more clearly describe the technical solutions of the embodiments of the present disclosure, accompanying drawings to be used in the detailed description of the disclosure will be briefly described hereinbelow. Obviously, the accompanying drawings described hereinbelow only illustrate some of the embodiments of the present disclosure, and those of ordinary skill in the art can also obtain other accompanying drawings therefrom without the need of making inventive efforts.

FIG. 1 is a flow chart of a method for eliminating residual image in a liquid crystal display panel of the present disclosure.

FIG. 2 is a schematic diagram of an embodiment of a method for eliminating residual image in a liquid crystal display panel of the present disclosure.

FIG. 3 is a block diagram of an embodiment of a liquid crystal display panel of the present disclosure.

### DETAILED DESCRIPTION

The following embodiments refer to the accompanying drawings for exemplifying specific implementable embodiments of the present disclosure. Moreover, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, the same reference symbol represents the same or similar components.

The present disclosure can solve the technical problem of the conventional method for the elimination residual image in a liquid crystal display panel, where since the reference voltage corresponding to each grayscale is adjusted from high grayscale to low grayscale sequentially, thereby increasing the time required for eliminating the residual images, and consuming optical modules required for eliminating the residual images.

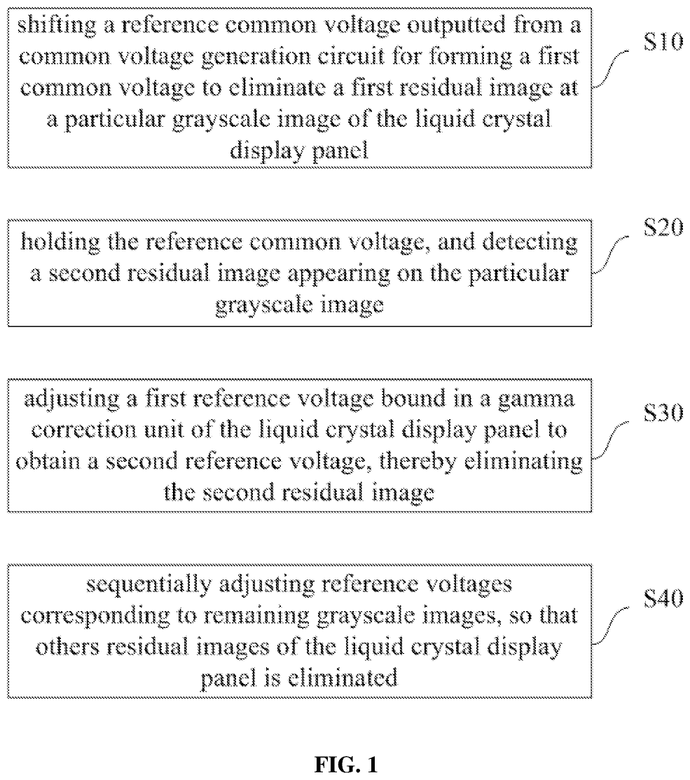

Referring to FIG. 1, which is a flow chart of a method for eliminating residual image in a liquid crystal display panel of the present disclosure. The method includes steps as follows.

S10, a reference common voltage output from a common voltage generation circuit is shifted for forming a first common voltage to eliminate a first residual image of a particular grayscale. image of the liquid crystal display panel.

Specifically, the S10 also includes steps as follows.

Firstly, parameters of the liquid crystal display panel are adjusted by a conventional gamma adjusting method, that is, a reference voltage bound of a gamma correction unit of the liquid crystal display panel is adjusted to be symmetric with respect to the common voltage. That is, an absolute value of the difference between a positive frame voltage of the reference voltage bound of the gamma correction unit and the common voltage is equal or approximately equal to an absolute value of the difference between a negative frame voltage of the reference voltage bound of the gamma correction unit and the common voltage. For example, if the common voltage is 4.5V, and the positive and negative frame voltages of the reference voltages bound of the gamma correction unit are set to 7V and 2V, respectively. At the same time, the display brightness of the liquid crystal display panel should be adjusted to minimize the flicker of the liquid crystal display panel. An external measuring instrument can be provided to detect the flicker of the liquid crystal display panel. When the current flicker is detected to be the smallest, the adjustment is stopped and the current parameter values are recorded.

Then, the liquid crystal display panel is maintained at the state of minimum flicker, and the process of detecting the residual images is started. Firstly, the liquid crystal display panel displays the residual detection image. In this embodiment, the residual detection image is a black and white checkerboard pattern. In other embodiments, the residual detection image may also be a black and white stripe pattern, or other black and white blocks pattern. After displaying the black and white checkerboard image for one minute, the image is switched to a specific grayscale image, such as a grayscale image of L128. The first residual image of the L128's grayscale image is observed. A reason for an occurrence of the first residual image is mainly due to a coupling between in-plane capacitances, so that the reference voltage bound of the gamma correction unit of the liquid crystal display panel is asymmetric with respect to the common voltage, and liquid crystals that are at this voltage for a long time will be polarized when lighting, resulting in residual images.

Before the first residual image appears, the reference common voltage of the liquid crystal display panel is symmetric with respect to the first reference voltage bound of the gamma correction unit of the liquid crystal display panel. However, the voltage applied to both ends of the liquid crystal by the in-plane coupling of the liquid crystal display panel is shifted from the first reference voltage to form a second reference voltage. At this time, the reference common voltage output by the common voltage generation circuit is shifted to form a first common voltage. The first common voltage is symmetric with respect to the coupled second reference voltage, and then the first residual image is eliminated, and the adjustment direction and amplitude of the reference common voltage are recorded.

Preferably, a selected value of the specific grayscale of the first common voltage ranges from greater than or equal to 48 grayscale to less than or equal to 127 grayscale.

S20, the reference common voltage is maintained, and a second residual image of the particular grayscale image is detected.

Specifically, the S20 also includes steps as follows.

Since the common voltage generation circuit is full-surface and cannot move with grayscale, when the reference common voltage output by the common voltage generation circuit is adjusted, only the first residual image of the liquid crystal display panel located in the partial grayscale image is eliminated. At this time, the reference common voltage is maintained, and the positive and negative voltages of the first reference voltage bound of the gamma correction unit of the liquid crystal display panel are not symmetric with the reference common voltage, and the second residual image that reappears on the particular grayscale image is detected.

S30, a first reference voltage bound of a gamma correction unit of the liquid crystal display panel is adjusted to obtain a second reference voltage, thereby eliminating the second residual image.

Specifically, the S30 also includes steps as follows.

When the liquid crystal display panel is converted into the particular grayscale image, the first reference voltage bound of the gamma correction unit of the liquid crystal display panel is adjusted to obtain the second reference voltage. A translation amplitude of the second reference voltage and the first reference voltage is the same as a translation amplitude of the first common voltage and the reference common voltage. A translation direction of the second reference voltage and the first reference voltage is opposite to a translation direction of the first common voltage and the reference common voltage. Positive and negative voltages of the second reference voltage are symmetric by utilizing the reference common voltage as a symmetry axis. The second residual image generated when the conversion to the particular grayscale image on the liquid crystal display panel is eliminated.

S40, reference voltages corresponding to remaining grayscale images are sequentially adjusted, so that others residual images of the liquid crystal display panel are eliminated.

Specifically, the S40 also includes steps as follows.

S401, an image of the liquid crystal display panel is switched between a residual detection image and a grayscale image of a preset time interval.

S402, the reference voltages corresponding to grayscale images are sequentially adjusted from a high grayscale image to a low grayscale image, where the reference voltage of one grayscale image is fixed after adjusting, and then a next grayscale image is adjusted. Positive and negative voltages of the reference voltage corresponding to each grayscale image are symmetric by utilizing the reference common voltage as a symmetry axis. Finally, the others residual images of the liquid crystal display panel are eliminated.

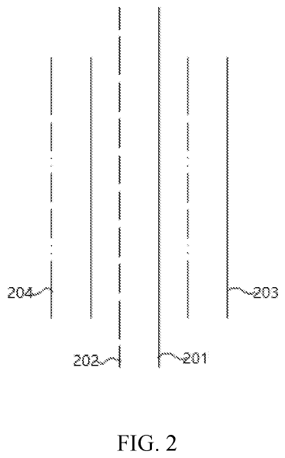

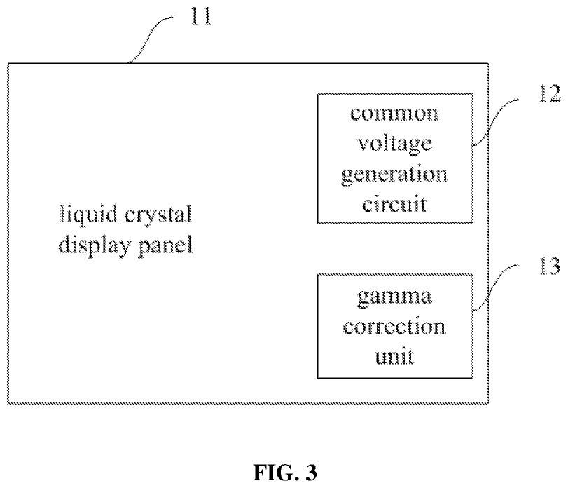

FIG. 2 is a schematic diagram of an embodiment of a method for eliminating residual image in a liquid crystal display panel of the present disclosure. FIG. 3 is a block diagram of an embodiment of a liquid crystal display panel of the present disclosure.

Firstly, a reference common voltage 201 output from a common voltage generation circuit 12 is shifted to the left by AV to form a first common voltage 202, so that a first residual image of a particular grayscale image on the liquid crystal display panel 11 is eliminated. At this time, positive and negative voltages of a first reference voltage 204 bound of a gamma correction unit 13 of the liquid crystal display panel 11 are symmetric by utilizing the first common voltage 202 as a symmetry axis, and the first residual image generated when the conversion to the particular grayscale image on the liquid crystal display panel 11 is eliminated.

Then, the reference common voltage 201 is maintained, and the positive and negative voltages of the first reference voltage 204 bound of the gamma correction unit 13 of the liquid crystal display panel 11 are not symmetric by utilizing the first common voltage 202 as the symmetry axis. The second residual image is reappeared when the liquid crystal display panel 11 is converted to the particular grayscale image.

Then, the first reference voltage bound of the gamma correction unit 13 of the liquid crystal display panel 11 is shifted to the right by AV to obtain a second reference voltage 203. At this time, positive and negative voltages of the second reference voltage 203 are symmetric by utilizing the reference common voltage 201 as a symmetry axis. The second residual image generated when the conversion to the particular grayscale image on the liquid crystal display panel 11 is eliminated.

The present disclosure proposes a new improvement method based on the prior art. The present disclosure is specifically for the particular grayscale image of the customer's attention. Firstly, a residual test image is lit by a checkerboard pattern, then switching to the particular grayscale image, adjusting the reference common voltage at this time until the residual image is eliminated. The adjustment direction and amplitude of the reference common voltage are recorded. The reference common voltage is fixed, and the reference voltage bound of the gamma correction unit of the liquid crystal display panel is shifted. The translation amplitude and direction are consistent with the adjustment of the reference common unit, thereby improving the residual image.

The present disclosure has the following advantages. In the method for eliminating residual image in a liquid crystal display panel of the present disclosure, the reference common voltage is maintained, and the grayscale adjustment is performed by changing the reference voltage, so the implementation process is simple. The time required for eliminating the residual images is reduced, and optical modules required for eliminating the residual images are decreased.

The above descriptions are merely preferable embodiments of the present disclosure, and are not intended to limit the scope of the present disclosure. Any modification or replacement made by those skilled in the art without departing from the spirit and principle of the present disclosure should fall within the protection scope of the present disclosure. Therefore, the protection scope of the present disclosure is subject to the appended claims.

1. A method for eliminating a residual image in a liquid crystal display panel, comprising:
S10, shifting a reference common voltage output from a common voltage generation circuit for forming a first common voltage, wherein a selected value of a specific grayscale of the first common voltage ranges from greater than or equal to 48 grayscale to less than or equal to 127 grayscale to eliminate a first residual image of a particular grayscale image of the liquid crystal display panel;
S20, maintaining the reference common voltage, and detecting a second residual image of the particular grayscale image;
S30, adjusting a first reference voltage bound of a gamma correction unit of the liquid crystal display panel to obtain a second reference voltage, thereby eliminating the residual image; and
S40, sequentially adjusting reference voltages corresponding to remaining grayscale images, so that others residual images of the liquid crystal display panel are eliminated.

2. The method for eliminating the residual image in the liquid crystal display panel as claimed in claim 1, wherein positive and negative voltages of the first reference voltage are symmetric by utilizing the first common voltage as a symmetry axis.

3. The method for eliminating residual image in the liquid crystal display panel as claimed in claim 1, wherein positive and negative voltages of the second reference voltage are symmetric by utilizing the reference common voltage as a symmetry axis.

4. The method for eliminating residual image in the liquid crystal display panel as claimed in claim 1, wherein a translation amplitude of the second reference voltage and the first reference voltage is same as a translation amplitude of the first common voltage and the reference common voltage.

5. The method for eliminating residual image in the liquid crystal display panel as claimed in claim 1, wherein a translation direction of the second reference voltage and the first reference voltage is opposite to a translation direction of the first common voltage and the reference common voltage.

6. The method for eliminating residual image in the liquid crystal display panel as claimed in claim 1, wherein the S10 further comprises:
S101, adjusting the liquid crystal display panel to minimize flicker displayed by the liquid crystal display panel;
S102, switching an image of the liquid crystal display panel between a residual detection image and the particular grayscale image to detect the first residual image of the particular grayscale image.

7. The method for eliminating residual image in the liquid crystal display panel as claimed in claim 6, wherein the S101 further comprises:
S1011, minimizing the flicker displayed by the liquid crystal display panel by adjusting a symmetry of the first reference voltage with respect to the reference common voltage and display brightness of the liquid crystal display panel.

8. The method for eliminating residual image in the liquid crystal display panel as claimed in claim 1, wherein a residual detection image is a black and white checkerboard pattern or a black and white stripe pattern.

9. The method for eliminating residual image in the liquid crystal display panel as claimed in claim 1, wherein the S40 further comprises:
S401, switching an image of the liquid crystal display panel between a residual detection image and a grayscale image of a preset time interval;
S402, sequentially adjusting the reference voltages corresponding to grayscale images from a high grayscale image to a low grayscale image, wherein the reference voltage of one grayscale image is fixed after adjusting, and then a next grayscale image is adjusted, and the others residual images of the liquid crystal display panel are finally eliminated.

10. A method for eliminating residual image in a liquid crystal display panel, comprising:
S10, shifting a reference common voltage output from a common voltage generation circuit for forming a first common voltage to eliminate a first residual image of a particular grayscale image of the liquid crystal display panel;
S20, maintaining the reference common voltage, and detecting a second residual image of the particular grayscale image;
S30, adjusting a first reference voltage bound of a gamma correction unit of the liquid crystal display panel to obtain a second reference voltage, thereby eliminating the residual image; and
S40, sequentially adjusting reference voltages corresponding to remaining grayscale images, so that others residual images of the liquid crystal display panel are eliminated.

11. The method for eliminating residual image in the liquid crystal display panel as claimed in claim 10, wherein positive and negative voltages of the first reference voltage are symmetric by utilizing the first common voltage as a symmetry axis.

12. The method for eliminating residual image in the liquid crystal display panel as claimed in claim 10, wherein positive and negative voltages of the second reference voltage are symmetric by utilizing the reference common voltage as a symmetry axis.

13. The method for eliminating residual image in the liquid crystal display panel as claimed in claim 10, wherein a translation amplitude of the second reference voltage and the first reference voltage is the same as a translation amplitude of the first common voltage and the reference common voltage.

14. The method for eliminating residual image in the liquid crystal display panel as claimed in claim 10, wherein a translation direction of the second reference voltage and the first reference voltage is opposite to a translation direction of the first common voltage and the reference common voltage.

15. The method for eliminating residual image in the liquid crystal display panel as claimed in claim 10, wherein the S10 further comprises:
S101, adjusting the liquid crystal display panel to minimize flicker displayed by the liquid crystal display panel;
S102, switching an image of the liquid crystal display panel between a residual detection image and the particular grayscale image to detect the first residual image of the particular grayscale image.

16. The method for eliminating residual image in the liquid crystal display panel as claimed in claim 15, wherein the S101 further comprises:
S1011, minimizing the flicker displayed by the liquid crystal display panel by adjusting a symmetry of the first reference voltage with respect to the reference common voltage and display brightness of the liquid crystal display panel.

17. The method for eliminating residual image in the liquid crystal display panel as claimed in claim 10, wherein a residual detection image is a black and white checkerboard pattern or a black and white stripe pattern.

18. The method for eliminating residual image in the liquid crystal display panel as claimed in claim 10, wherein the S40 further comprises:
S401, switching an image of the liquid crystal display panel between a residual detection image and a grayscale image of a preset time interval;
S402, sequentially adjusting the reference voltages corresponding to grayscale images from a high grayscale image to a low grayscale image, wherein the reference voltage of one grayscale image is fixed after adjusting, and then a next grayscale image is adjusted, and the others residual images of the liquid crystal display panel are finally eliminated.
